(19) United States
(12) Patent Application Publication
(10) Pub. No.: US 2020/0300973 A1
(43) Pub. Date: Sep. 24, 2020

(54) SYSTEM AND METHOD FOR OBJECT CLASSIFICATION IN A ROADWAY ENVIRONMENT

(71) Applicants: Joseph Laski, Stoneham, MA (US); Richard Garner, Arlington, MA (US); Michael Quilici, Essex, MA (US)

(72) Inventors: Joseph Laski, Stoneham, MA (US); Richard Garner, Arlington, MA (US); Michael Quilici, Essex, MA (US)

(73) Assignee: OSRAM GmbH, Munich (DE)

(21) Appl. No.: 16/358,603

(22) Filed: Mar. 19, 2019

(51) Int. Cl. G01S 7/48; B60W 30/18

(52) U.S. Cl. CPC G01S 7/4802; B60W 30/18; G05D 1/0214; B60W 2550/141; B60W 2420/52; B60W 2550/12

(57) ABSTRACT

A light detection and ranging system 100 for use with a vehicle 500. The system includes a transmitter 102 configured to transmit three transmission wavelengths nominally in a range from 800 nm to 1700 nm. A receiver is configured to receive three reflected signals 114, each of the three reflected signals 114 being a portion of an associated one of the three transmission wavelengths reflected to the receiver 104 from a roadway object 112. A controller 106 provides a categorization output in response to comparing reflectance values of the three reflected signals 114 to categorize the roadway object 112 into one of a plurality of pre-defined material-type categories. A method of controlling the travel of a vehicle based on a categorization output from a controller 106 is also provided.

### TECHNICAL FIELD

The present application relates to a system and method for object classification in a roadway environment.

### BACKGROUND

A variety of sensor systems may be incorporated into a vehicle for detecting objects to the front, rear, side or corner of the vehicle while the vehicle is traveling or stationary. In response to outputs of one or more sensor systems, a vehicle may provide an alert to a driver, provide automatic braking control and/or provide automatic steering control when the vehicle is in danger of striking an object. On example of a system useful for this purpose is a light detection and ranging (LiDAR) system.

In general, known LiDAR sensor systems used in vehicle applications transmit one or more wavelengths of light from a transmitter mounted to the vehicle. The transmitted wavelengths are reflected from objects external to the vehicle and are received at a receiver mounted to the vehicle. The system may analyze characteristics of the received signals to identify the type of objects in external to the vehicle.

One example of a LiDAR sensor system used in vehicles is described in U.S. Patent Application Publication number US 2018/0210083 (Fasching et al., hereinafter “Fasching”). Fasching discloses a multi-wavelength LiDAR system using characteristics of reflected signals, such as intensity and polarization, for object detection, identification and classification. In one configuration disclosed in Fasching, an object is encoded with multiple ancillary components and three wavelengths are transmitted toward the object from a transmitter. The three transmitted wavelengths may be in the range between 0.25 microns and 15 microns, between 0.7 microns and 15 microns, or between 0.7 microns and 2 microns. The ancillary components applied to the object encode information in the reflected signals that may be used to detect, identify and classify the object. Another example of a LiDAR sensor system used for object detection, identification and classification in vehicles is described in U.S. Pat. No. 7,026,600 (Jamieson et al., hereinafter “Jamieson”). Jamieson discloses a multi-wavelength LiDAR system using four wavelengths in a range of 1.06 to 2.0 microns for object detection, identification and classification.

LiDAR systems are also used in horticultural applications. Examples of LiDAR systems used in horticultural applications are described in Z. Bo; et al.; A Multi-Wavelength Canopy LiDAR for Vegetation Monitoring: System Implementation and Laboratory-Based Tests; Procedia Environmental Sciences 10 (2011) 2775-2782; Gong Wei et al.; Multi-wavelength canopy LiDAR for remote sensing of vegetation: Design and system performance; ISPRS Journal of Photogrammetry and Remote Sensing 69 (2012) 1-9; Gong Wei et al.; Investigating the Potential of Using the Spatial and Spectral Information of Multispectral LiDAR for Object Classification; Sensors 2015, 15, 21989-22002; doi:10.3390/s150921989; and B. Chen et al.; Multispectral LiDAR Point Cloud Classification: A Two-Step Approach; Remote Sens. 2017, 9, 373; doi:10.3390/rs9040373.

Unfortunately, known LiDAR systems used in vehicles suffer from several disadvantages. For example, complex systems including multiple wavelengths require costly transmitter, receiver and processing configurations that increase the cost and complexity of a vehicle. In addition, the transmitter and receiver may be cumbersome and difficult to mount in an inconspicuous location in the vehicle. Also, LiDAR systems that operate using ancillary components such as reflectors that are attached to an object are impractical for use in a roadway environment since it would not be practically feasible to apply the components to all the objects that may be encountered in the roadway.

### BRIEF DESCRIPTION OF THE DRAWINGS

Reference should be made to the following detailed description which should be read in conjunction with the following figures, wherein like numerals represent like parts:

FIG. 1 is a functional block diagram of a light detection and ranging system consistent with at least one embodiment of the present disclosure.

FIG. 2 includes plots of theoretical normalized intensity of reflected signals at three different wavelengths for each of three different object materials consistent with at least one embodiment of the present disclosure.

FIG. 3 includes plots of theoretical normalized intensity of reflected signals at three different wavelengths for each of three different object materials consistent with at least one embodiment of the present disclosure.

FIG. 4 includes plots of theoretical normalized intensity of reflected signals at three different wavelengths for each of six different object materials consistent with at least one embodiment of the present disclosure.

FIG. 5 is a perspective view of a vehicle including a light detection and ranging system consistent with at least one embodiment of the present disclosure.

### DETAILED DESCRIPTION

In general, one embodiment of the present disclosure features a light detection and ranging system (LiDAR) for classifying objects in roadway environment. The LiDAR system uses only three wavelengths in a range from 800 nanometers(nm) to 1700 nm to classify a useful range of objects encountered in the roadway environment into broad material-type classifications. Advantageously, the LiDAR system does not require ancillary objects, such as encoders or reflectors, to be applied to the objects to provide the broad classifications. Also, since the LiDAR system uses only three wavelengths in a range from 800 nm to 1700 nm, the transmitter and receiver of the system may be constructed from commercially available components. The transmitter and receiver also include fewer components, are less expensive to manufacture and may be physically smaller than systems using more than three wavelengths or using a different wavelength range. A physically smaller size of the system allows the system to be easily mounted on a vehicle (such as, but not limited to locally and remotely driven and autonomous automobiles, aircraft, marine vessels and other vehicles) in a variety of locations, e.g. on the inside or outside of the vehicle to the front, rear, side and/or comer(s) of the vehicle. Moreover, by providing broad material-type classifications as opposed to detailed object identification and classification, signal processing in a controller for the system may be performed at sufficient speed, e.g. in real time (which is conventionally known to be within a few hundred milliseconds), for automotive applications given the rate of travel for modem vehicles and can be performed using relatively simple computations.

Some embodiments of the present disclosure feature a LiDAR system for providing broad material-type classification of a useful range of objects in roadway environment using a plurality of wavelengths in a range from 800 m to 1700 nm. The system provides a categorization output representative of a broad material-type classification for each identified object. Travel of the vehicle (e.g. the direction, speed, acceleration, pitch, yaw and/or roll) may be controlled in response to the categorization output. For example, a controller of the system may provide one categorization output indicating that a first object in the direction of travel of the vehicle is a roadway material and another categorization output indicating a second object in the direction of travel of the vehicle is a non-roadway material, e.g. a building material. The controller may communicate with a vehicle controller to control a vehicle steering system control the direction of travel of the vehicle away from the object classified as a non-roadway material and toward the object classified as a roadway material and/or to slow or stop the vehicle. The system may be used to supplement or augment information from other sensors in an adaptive steering system of a driven vehicle or the steering system of an autonomous vehicle.

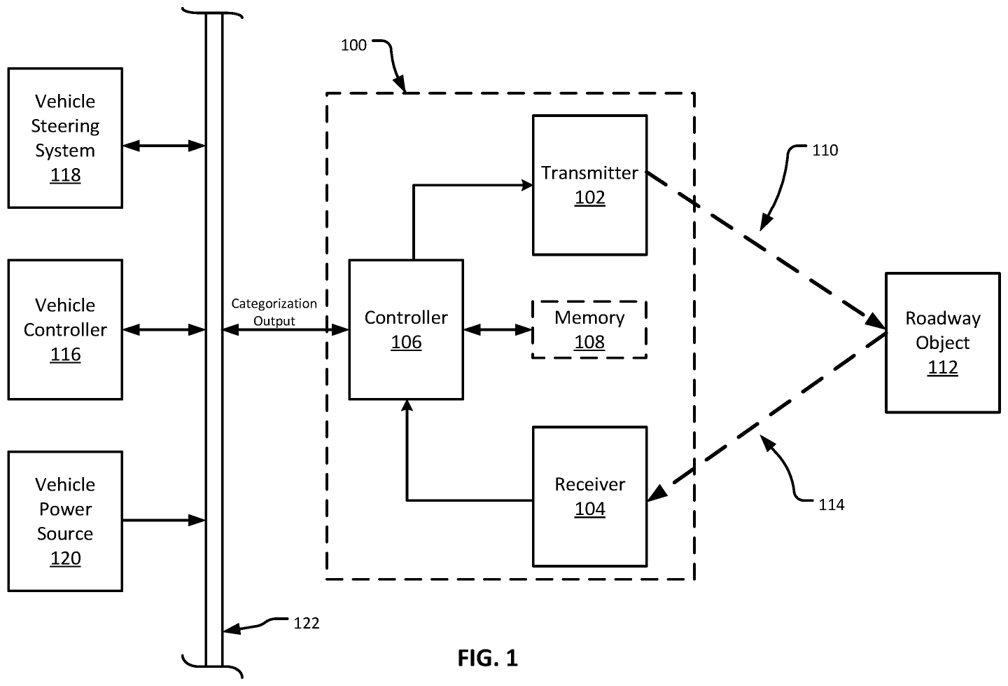

Turning now to FIG. 1, one example embodiment of a LiDAR system 100 consistent with the present disclosure is generally illustrated in functional block diagram form. In the illustrated example, the system 100 includes a transmitter 102, a receiver 104, a controller 106 and an optional non-transitory computer-readable memory 108. In general, the transmitter 102 is configured to transmit light 110 at a plurality of transmission wavelengths in a range from 800 nm to 1700 nm from the vehicle toward a roadway object 112. The receiver 104 is configured to receive at least a portion of each of the transmission wavelengths reflected to the receiver 104 as reflected signals 114 from the roadway object 112. The controller 106 is configured to provide a categorization output in response to comparing reflectance values of reflected signals 114 received at the receiver 104.

The optional memory 108 may store instructions and/or data used by the controller 106 to provide the categorization output. For example, the optional memory 108 may store the pre-defined material type categories associated with the roadway materials and/or reflectance values (e.g. reflected intensity and/or polarization) associated with the roadway materials. The controller 106 may access this information in the optional memory 108 to perform computations associated with providing the categorization output. In some embodiments, the data stored in the optional memory 108 may be manually or automatically updated and/or extended to include data from external data sources.

In some embodiments, the categorization output from the controller 106 may be coupled to a vehicle controller 116. The controller 106 may be responsive to commands from the vehicle controller 116 to operate the LiDAR system 100, e.g. continuously, periodically, on demand, etc. The vehicle controller 116 may be configured to provide an output to a vehicle steering system 118 to control travel (e.g. the direction, speed, acceleration, pitch, yaw and/or roll) of the vehicle at least partially in response to the categorization output. The vehicle controller 116 may take a configuration similar to a known engine control module (ECM) and the vehicle steering system 118 may be a known adaptive steering system or autonomous vehicle steering system configured to control the direction, speed, acceleration, pitch, yaw and/or roll of the vehicle in response to output from the vehicle controller 116. The system 100 may be powered by a vehicle power source 120, e.g. a 12VDC source. In some embodiments, the system 100, the vehicle controller 116, the vehicle steering system 118 and the vehicle power source 120 may be coupled to each other by way of a vehicle CAN-bus, LIN-bus, or similar vehicle bus (hereinafter generally referred to as the bus 122). Other vehicle sensors/controllers may also be electrically coupled to the bus 122.

The transmitter 102 may take a variety of known configurations for transmitting a plurality of wavelengths simultaneously and/or sequentially in a wavelength range from 800 nm to 1700 nm. The transmitter 102 includes one or more light sources from which the transmitted wavelengths originate, and is not simply a surface of a vehicle that reflects light from the sun or other light source external to the vehicle. The transmitter 102 may, for example, include discrete light sources, e.g. lasers, laser diodes, or light emitting diodes, each tuned to transmit an associated one of the plurality of wavelengths. In addition, or alternatively, the transmitter 102 may include one or more broadband light sources configured to transmit the wavelengths. The wavelengths are transmitted by the transmitter 102 under the control of the controller 106 in a manner such that a baseline magnitude of optical power and/or baseline polarization is known (at least relative to each other). This allows the reflected signals 114 associated with each wavelength to be compared to the baseline as a measure of the spectral reflectivity and/or reflected polarization of the roadway object 112. A variety of optical components may be provided in the transmitter 102 for directing the transmitted light from of the vehicle over a desired field of view encompassing the roadway environment to the front, rear, side(s) and/or corner(s) of the vehicle.

The receiver 104 may take a variety of known configurations for receiving the reflected signals 114 associated with the transmitted wavelengths and/or polarizations. The receiver 104 may, for example, include one or more bandpass filters for passing reflected signals 114 at the transmitted wavelengths and optics for directing the reflected signals 114 at the transmitted wavelengths and/or polarizations to associated optical detectors. The optical detectors may include any known detector configuration for converting the reflected signals 114 into electrical signals representative of one or more characteristics, e.g. intensity, polarization, etc. Known optical detectors include, for example, avalanche photodiodes, PIN photodiodes, single-photon photodiodes, a photo-multiplier tube, etc.

The receiver 104 provides one or more outputs to the controller 106 representative of reflectance values, e.g. intensity and/or polarization, of the each of the reflected signals 114 at the associated transmitted wavelengths. The controller 106 is configured to provide a categorization output in response to comparing reflectance values received at the receiver 104. The categorization output is representative of the roadway object 112 being categorized into an associated one of a plurality of pre-defined material-type categories. Each of the pre-defined material-type categories includes an associated plurality of potential material types associated with a roadway environment.

It has been found that classification of roadway objects 112 into broad material-type classifications is useful in automated vehicle control applications since the materials associated with roadway objects 112 are generally limited to a relatively small number of materials. For example, the objects in a roadway environment generally include materials such as asphalt, concrete, brick, wood, metals, vegetation and paint pigments found in driving lanes and in the proximal adjoining areas such as curbs, sidewalks, road shoulders and median strips. Highways may have a fewer number of material types than roadways in suburban and urban areas, although even in suburban and urban areas the regions up to about three meters from the curb are generally managed so that objects having relatively few material types appear in these areas. The materials associated with the roadway environment may be identified and classified into useful broad material-type categories.

Any number of materials may be categorized into broad material-type categories in a system 100 consistent with the present disclosure. In general, each category may include a plurality of materials within the material-type category and the number of material-type categories may be selected to provide useful information for vehicle control. In one non-limiting example, materials associated with a roadway environment may be identified as galvanized sheet metal, asphalt, concrete, white bark pine tree, red brick, lawn grass, cinder block, coated steel girder, wood beam, snow or ice, melting snow, and cobalt blue paint pigment. This non-limiting example is provided for ease of explanation only. For example, a cobalt blue paint pigment is included in this example material types just as an example of a paint pigment. Of course, other paint pigments, e.g. for road signs, fire hydrants, other vehicles etc. would be encountered in a roadway environment. Also, other materials including, but not limited to, clothing, textile, fur, etc. may be associated with the roadway environment and be included in one or more broad material-type categories.

With respect to the non-limiting example, these twelve specific material types may be categorized into six broad material-type categories such as:

(1) snow and ice, including materials such as snow, ice and melting snow;

(2) paint, including cobalt blue paint pigment and other paints of different pigments

(3) wood and vegetation, including white bark pine tree, lawn grass and other wood and vegetation

(4) asphalt, including asphalts of different types;

(5) building materials, including building materials of different types such as concrete, brick, cinder block, coated steel girders and wood beams; and

(6) galvanized sheet metal, including highway guard rail material and other galvanized sheet metal materials.

The number of material-type categories may vary based on the roadway environment where the system 100 is intended for use. For example, if the system 100 will be limited to a highway environment fewer material-type categories may be necessary than a system 100 intended for use in an urban or suburban environment. In some embodiments, for example, five or six material type categories may be used to provide vehicle control.

In a system 100 consistent with the present disclosure, broad material-type categorization may be achieved using only three transmitted wavelengths in a range of wavelengths from 800 nm to 1700 nm. In some embodiments, this may be achieved by measuring the reflectivity spectra for a range of materials expected to be encountered in the roadway environment. The term “reflectivity spectra” as used herein refers to the intensity of light reflected by an object across a range of wavelengths imparted on the object. The reflectivity spectra for a wide range of materials is known. For example, the reflectivity spectra for the twelve materials identified in the non-limiting example above may be obtained the U.S. Geological Survey (USGS) web site.

In addition, or alternatively, a polarization spectra may be identified for the range of materials expected to be encountered in the roadway environment. The term “polarization spectra” as used herein refers to the change in polarization from a baseline polarization exhibited in the wavelengths reflected by an object across a range of wavelengths imparted on the object. For ease of explanation, example embodiments may be described herein with respect to the reflectivity spectra of roadway materials. It is to be understood, however, that a system 100 consistent with the present disclosure may perform broad material-type categorization using any characteristic or combination of characteristics, e.g. intensity, polarization, phase and/or wavelength, of the reflected signals 114.

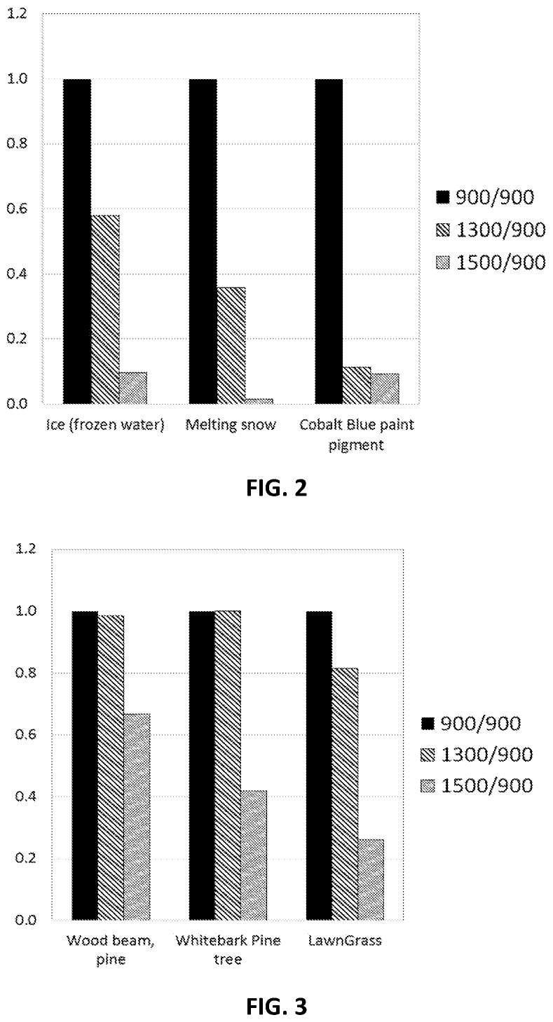

Once the reflectivity spectra for the range of materials expected to be encountered in the roadway is known, relationships between the reflectivity associated with different wavelengths for different materials may be identified for purposes of categorizing the materials. With respect to the non-limiting example referenced above, for example, FIGS. 2-4 include plots of theoretical intensity of reflected signals 114 at three different wavelengths for each of several different materials. The three wavelengths used in this non-limiting example are nominally 900 nm, 1300 nm and 1500 nm. The intensity values shown in FIGS. 2-4 for the 900 nm, 1300 nm and 1500 nm wavelengths were derived from the data associated with the referenced materials on the USGS website. The data shown in FIGS. 2-4 is normalized to the reflected intensity associated with the 900 nm wavelength. Thus, the notation 900/900 refers to the intensity value at the 900 nm wavelength normalized to 900 nm (normalized intensity of 1.0), the notation 1300/900 refers to the intensity value at the 1300 nm wavelength normalized to 900 nm, and the notation 1500/900 refers to the intensity value at the 1500 nm wavelength normalized to 900 nm.

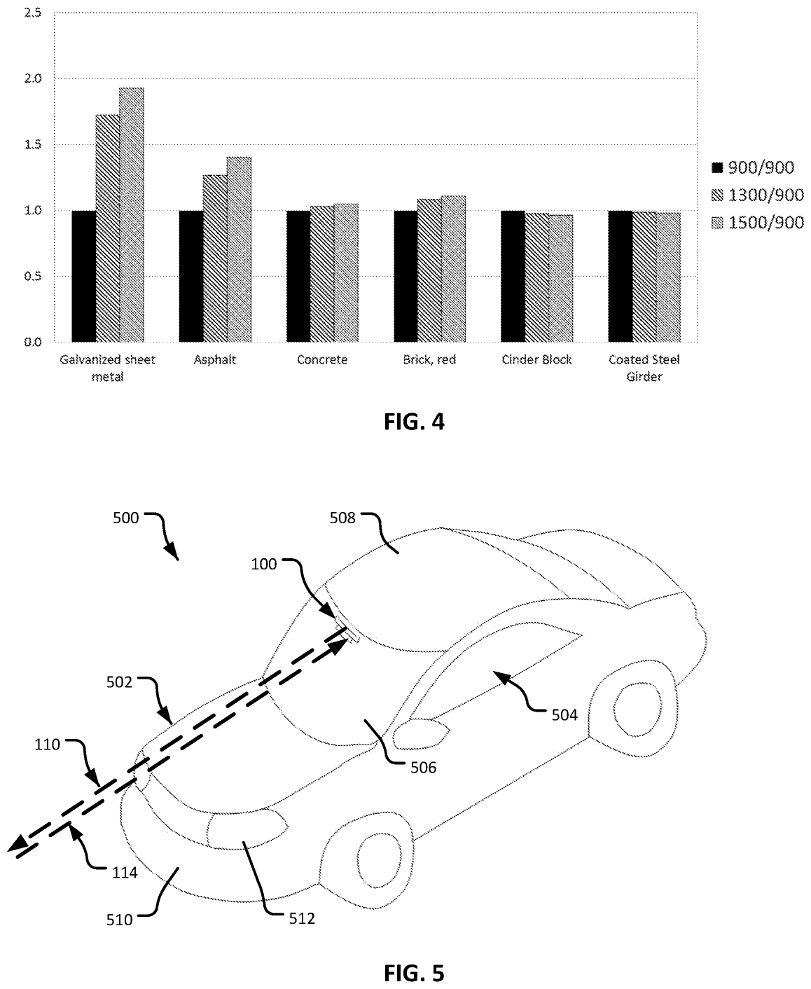

FIG. 2 includes plots of plots of theoretical intensity of reflected signals 114 at 900 nm, 1300 nm and 1500 nm for ice, melting snow and cobalt blue paint pigment. FIG. 3 includes plots of plots of theoretical intensity of reflected signals 114 at 900 nm, 1300 nm and 1500 nm for wood beam (pine), white bark pine tree, and lawn grass. FIG. 4 includes plots of plots of theoretical intensity of reflected signals 114 at 900 nm, 1300 nm and 1500 nm for galvanized sheet metal, asphalt, concrete, red brick, cinder block and coated steel girder. From the plots shown in FIGS. 2-4 relationships between the intensity of the reflected signals 114 may be identified for purposes of assigning each of the identified materials to one of the six broad material-type classifications identified in the non-limiting example above. For example, using the notations 1500/900, 1300/900 and 900/900 to refer to the normalized intensity values shown in FIGS. 2-4 for the 1500 nm, 1300 nm and 900 nm wavelengths, respectively, the following ratios may be used to categorize the materials into the six broad material-type classifications:

(1) If 1500/900<0.15 and 1300/900=0.2, then the material may be categorized as ice or snow;

(2) If 1300/900<0.2, then the material may be categorized as paint pigment;

(3) If 0.2<1500/900<0.8, then the material may be categorized as wood or vegetation;

(4) If 0.9<1300/900 and 1500/900<1.3, then the material may be categorized as building material;

(5) If 1.2<1300/900 and 1500/900<1.6, then the material may be categorized as asphalt; and

(6) If 1.5<1300/900 and 1500/900<2.3, then the material may be categorized as galvanized sheet metal.

The twelve-materials may thus be categorized into the six broad material-type categories using only three wavelengths, i.e. 900 nm, 1300 nm and 1500 nm, in the non-limiting example described above. The particular wavelengths used in a system 100 consistent with the present disclosure may be chosen or optimized based on the materials expected to be encountered in a roadway environment. Advantageously, however, the wavelengths may all be in the range from 800 nm-1700 nm. Using wavelengths in this range allows use of commercially available laser transmitters, transmitter optics, receiver filters, receiver optics and photodetectors.

The controller 106 may be configured to provide a categorization output in response to comparing reflectance values received at the receiver 104 by calculating ratios of the reflectance values, e.g. as described in connection with the non-limiting example set forth above: In addition, or alternatively, the controller may execute a machine learning algorithm using ratios to progressively learn and categorize a range of materials encountered in a roadway environment. A variety of machine learning technologies are well known, including, for example, decision tree learning, association rule learning, inductive logic programming, support vector machines, etc. Since the controller may provide the categorization output using simple data calculations, e.g. ratios or machine learning calculations, a system 100 consistent with the present disclosure may exhibit very fast computation speed compared to systems that provide more-detailed object identification or classification. A categorization output may be provided at sufficient speed, e.g. in real time, for automotive applications given the rate of travel for modern vehicles.

Embodiments of a system 100 consistent with the present disclosure use only three wavelengths in a range from 800 nm to 1700 nm to produce a categorization output representative of a broad material-type categorization of roadway objects 112 without using ancillary components such as reflectors or encoders coupled to the roadway objects 112 This provides significant advantages. For example, use of a wavelength range from 800 nm to 1700 nm allows construction of the system using commercially available transmitter 102 and receiver 104 components. Also, since the transmitter 102 and receiver 104 are limited to three wavelengths the transmitter 102 and receiver 104 of the system 100 include fewer components, are less expensive to manufacture and may be physically smaller than systems using more than three wavelengths.

A physically smaller size of the system 100 allows the system 100 to be easily mounted on a vehicle in a variety of locations. FIG. 5, for example, illustrates one example of a vehicle 500 including a system 100 consistent with the present disclosure. In the illustrated embodiment, the vehicle 500 includes a chassis 502 defining a passenger compartment 504 with a windshield 506. As shown, the system 100 may be mounted on, or adjacent to, the windshield 506 within the passenger compartment 504 to transmit light 110 through the windshield 506 of the vehicle 500 and to receive reflected signals 114 through the windshield 506 from a roadway object 112 (FIG. 1). The system 100 may be sized for mounting in any convenient and/or inconspicuous place on the vehicle 500, e.g. on the vehicle roof 508, bumper 510, etc., to provide broad material-type classification of objects to the front, rear, side(s) and/or comer(s) of the vehicle.

In some embodiments consistent with the present disclosure, the system 100 may transmit a plurality of wavelengths (not limited to three wavelengths) in a range from 800 nm to 1700 nm and the controller 106 may provide a categorization output representative of a broad material-type classification for each identified roadway object 112. Travel (e.g. the direction, speed, acceleration, pitch, yaw and/or roll) of the vehicle 500 may be controlled in response to one or more of the categorization outputs. For example, a controller 106 of the system 100 may provide one categorization output indicating that a first roadway object 112 (e. g. in the direction of travel of the vehicle 500) is a roadway material, such as asphalt, and another categorization output indicating a second roadway object 112 (e.g. in the direction of travel of the vehicle 500) is not a roadway material, e.g. a building material, snow or ice, paint, wood or vegetation or galvanized sheet metal. The controller 106 may provide the categorization outputs to the vehicle controller 116 and the vehicle controller 116 may provide an output to the vehicle steering system 118 to maintain the direction of travel of the vehicle 500 in a direction away from the roadway object 112 classified by the categorization output as a non-roadway material and toward the roadway object 112 classified by the categorization output as a roadway material.

In addition, or alternatively, in an emergency or evasion situation the vehicle controller 116 may provide an output to a vehicle steering system 118 in response to one or more categorization outputs from the controller 106 to slow or stop the vehicle 500 and/or steer the vehicle 500 away from a roadway object 112 deemed by the vehicle controller 116 to represent a greater risk of damage or injury. For example, the vehicle controller 116 may be configured to steer the vehicle 500 away from an object classified by the categorization output from the controller 106 as a building material and toward the object classified by the categorization output as a wood or vegetation. In addition, or alternatively, the vehicle controller 116 may be configured to slow or stop the vehicle 500 when one or more categorization outputs is representative of an object being classified as a non-roadway material. A variety of other steering system responses may be implemented by the vehicle controller 116 in response to one or more categorization outputs from the controller 106.

According to one aspect, the present disclosure includes a light detection and ranging system 100 for use with a vehicle 500. The light detection and ranging system 100 includes: a transmitter transmitter 102 configured to be coupled to the vehicle 500 and to emit light 110 at three transmission wavelengths nominally in a range from 800 nm to 1700 nm; a receiver 104 configured to be coupled to the vehicle 500 and to receive three reflected signals 114, each of the three reflected signals 114 being a portion of an associated one of the three transmission wavelengths reflected to the receiver 104 from a roadway object 112 external to the vehicle 500; and a controller 106 configured to be coupled to the receiver 104, the controller 106 configured to provide a categorization output in response to comparing reflectance values of the three reflected signals 114. The categorization output is representative of the roadway object 112 being categorized into an associated one of a plurality of pre-defined material-type categories, each of the plurality of pre-defined material-type categories comprising an associated plurality of potential material types associated with a roadway environment.

According to another aspect, the present disclosure includes a method of controlling the travel of a vehicle 500 including: transmitting light 110 at a plurality of transmission wavelengths from a transmitter 102 coupled to the vehicle 500, the transmission wavelengths being nominally in a range from 800 nm to 1700 nm; receiving a plurality of reflected signals 114 at a receiver 104 coupled to the vehicle 500, each of the reflected signals 114 being a portion of an associated one of the plurality transmission wavelengths reflected from a roadway object 112 external to the vehicle 500; comparing reflectance values of the plurality of reflected signals 114 in a controller 106 coupled to the vehicle 500; providing a categorization output from the controller 106 in response to the comparing the reflectance values of the plurality of reflected signals 114, the categorization output being representative of the roadway object 112 being categorized into an associated one of a plurality of pre-defined material-type categories, each of the plurality of pre-defined material-type categories comprising an associated plurality of potential material types associated with a roadway environment; and controlling the travel of the vehicle 500 in response to the categorization output.

According to another aspect, the present disclosure includes a vehicle 500 including: a chassis 502; and a light detection and ranging system 100 coupled to the chassis 502. The light detection and ranging system 100 includes: a transmitter 102 configured to be coupled to the vehicle 500 and to emit light 110 at three transmission wavelengths nominally in a range from 800 nm to 1700 nm; a receiver 104 configured to be coupled to the vehicle 500 and to receive three reflected signals 114, each of the three reflected signals 114 being a portion of an associated one of the three transmission wavelengths reflected to the receiver 104 from a roadway object 112 external to the vehicle 500; and a controller 106 configured to be coupled to the receiver 104, the controller 106 configured to provide a categorization output in response to comparing reflectance values of the three reflected signals 114. The categorization output is representative of the roadway object 112 being categorized into an associated one of a plurality of pre-defined material-type categories, each of the plurality of pre-defined material-type categories comprising an associated plurality of potential material types associated with a roadway environment.

Embodiments of the methods described herein may be implemented using a controller, processor and/or other programmable device. To that end, the methods described herein may be implemented on a tangible, non-transitory computer readable storage medium, e.g. memory 108, having instructions stored thereon that when executed by one or more processors perform the methods. Thus, for example, controller 106 may include or access a storage medium, e.g. memory 108, to store instructions (in, for example, firmware or software) to perform the operations described herein. The storage medium may include any type of non-transitory tangible computer readable medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

The functions of the various elements shown in the figures, including any functional blocks labeled as “controller”, such as the controller 106, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term “controller” should not be construed to refer exclusively to hardware capable of executing software, and may implicitly include, without limitation, digital signal processor (DSP) hardware, network processor, application specific integrated circuit (ASIC), field programmable gee array (FPGA), read-only memory (ROM) for storing software, random access memory (RAM), and non-volatile storage. Other hardware, conventional and/or custom, may also be included.

All definitions, as defined and used herein, should be understood to control over dictionary definitions, definitions in documents incorporated by reference, and/or ordinary meanings of the defined terms.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection. Elements, components, modules, and/or parts thereof that are described and/or otherwise portrayed through the figures to communicate with, be associated with, and/or be based on or in response to, something else, may be understood to so communicate, be associated with, and/or be based on in a direct and/or indirect manner, unless otherwise stipulated herein.

Throughout the entirety of the present disclosure, use of the articles “a” and/or “an” and/or “the” to modify a noun may be understood to be used for convenience and to include one, or more than one, of the modified noun, unless otherwise specifically stated. The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

As used herein, use of the term “nominal” or “nominally” when referring to an amount means a designated or theoretical amount that may vary from the actual amount. Use of the phrase “in a range from X to Y” is meant to be inclusive of X and Y, unless otherwise specifically stated. The terms “comprising”, “including” and “having” are intended to be inclusive and mean that there may be additional elements other than the listed elements.

An abstract is submitted herewith. It is pointed out that this abstract is being provided to comply with the rule requiring an abstract that will allow examiners and other searchers to quickly ascertain the general subject matter of the technical disclosure. It is submitted with the understanding that it will not be used to interpret or limit the scope or meaning of the claims, as set forth in the rules of the U.S. Patent and Trademark Office.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure. Future-filed applications claiming priority to this application may claim the disclosed subject matter in a different manner and generally may include any set of one or more limitations as variously disclosed or otherwise demonstrated herein.

The following non-limiting reference numerals are used in the specification:

100 system

102 transmitter

104 receiver

106 controller

108 non-transitory computer-readable memory

110 light

112 roadway object

114 reflected signals

116 vehicle controller

118 vehicle steering system

120 vehicle power source

122 bus

500 vehicle

502 chassis

504 passenger compartment

506 windshield

508 roof

510 bumper

512 headlamp assembly

We claim:

1. A light detection and ranging system (100) for use with a vehicle (500), the light detection and ranging system (100) comprising:
a transmitter (102) configured to be coupled to the vehicle (500) and to emit light (110) at three transmission wavelengths nominally in a range from 800 nm to 1700 nm;
a receiver (104) configured to be coupled to the vehicle (500) and to receive three reflected signals (114), each of the three reflected signals (114) being a portion of an associated one of the three transmission wavelengths reflected to the receiver (104) from a roadway object (112) external to the vehicle (500); and
a controller (106) configured to be coupled to the receiver (104), the controller (106) configured to provide a categorization output in response to comparing reflectance values of the three reflected signals (114), the categorization output being representative of the roadway object (112) being categorized into an associated one of a plurality of pre-defined material-type categories, each of the plurality of pre-defined material-type categories comprising an associated plurality of potential material types associated with a roadway environment.

2. The light detection and ranging system (100) according to claim 1, wherein the controller (106) is configured to control the travel of the vehicle (500) in response to the categorization output.

3. The light detection and ranging system (100) according to claim 1, wherein the controller (106) is configured to compare the reflectance values of the three reflected signals (114) by determining ratios of the reflectance values of the three reflected signals (114).

4. The light detection and ranging system (100) according to claim 1, wherein the plurality of pre-defined material-type categories comprises at least five pre-defined material-type categories.

5. The light detection and ranging system (100) according to claim 1, wherein the plurality of pre-defined material-type categories comprises a plurality of material categories selected from a group consisting of: snow and ice, paint, wood and vegetation, asphalt, building materials and galvanized sheet metal.

6. The light detection and ranging system (100) according to claim 1, wherein the reflectance values are intensity values of the three reflected signals (114).

7. A method of controlling the travel of a vehicle (500) comprising:
transmitting light (110) at a plurality of transmission wavelengths from a transmitter (102) coupled to the vehicle (500), the transmission wavelengths being nominally in a range from 800 nm to 1700 nm;
receiving a plurality of reflected signals (114) at a receiver (104) coupled to the vehicle (500), each of the reflected signals (114) being a portion of an associated one of the plurality transmission wavelengths reflected from a roadway object (112) external to the vehicle (500);
comparing reflectance values of the plurality of reflected signals (114) in a controller (106) coupled to the vehicle (500);
providing a categorization output from the controller (106) in response to the comparing the reflectance values of the plurality of reflected signals (114), the categorization output being representative of the roadway object (112) being categorized into an associated one of a plurality of pre-defined material-type categories, each of the plurality of pre-defined material-type categories comprising an associated plurality of potential material types associated with as roadway environment; and
controlling the travel of the vehicle (500) in response to the categorization output.

8. The method of controlling the travel of a vehicle (500) according to claim 7, the method further comprising:
receiving a second plurality of reflected signals (114) at the receiver (104), each of the second plurality of reflected signals (114) being a portion of an associated one of the plurality transmission wavelengths reflected from a second roadway object (112) external to the vehicle (500);
comparing reflectance values of the second plurality of reflected signals (114) in the controller (106); and
providing a second categorization output from the controller (106) in response to the comparing the reflectance values of the second plurality of reflected signals (114), the second categorization output being representative of the second roadway object (112) being categorized into an associated one of a plurality of pre-defined material-type categories,
wherein the controlling the travel of the vehicle (500) in response to the categorization output comprises controlling the travel of the vehicle (500) in response to the categorization output and the second categorization output to direct the vehicle (500) toward the first roadway object and away from the second roadway object.

9. The method of controlling the travel of a vehicle (500) according to claim 8, wherein the categorization output is representative of the roadway object (112) being categorized into an associated one of the plurality of pre-defined material-type categories comprising roadway materials and wherein the second categorization output is representative of the roadway object (112) being categorized into an associated one of the plurality of pre-defined material-type categories comprising a non-roadway material.

10. The method of controlling the travel of a vehicle (500) according to claim 7, wherein the transmitting light (110) at a plurality of transmission wavelengths comprises transmitting light (110) at three wavelengths, and wherein the receiving a plurality of reflected signals (114) comprises receiving three reflected signals (114).

11. The method of controlling the travel of a vehicle (500) according to claim 7, wherein the comparing reflectance values of the plurality of reflected signals (114) comprises determining ratios of the reflectance values of the plurality of the reflected signals (114).

12. The method of controlling the travel of a vehicle (500) according to claim 7, wherein the plurality of pre-defined material-type categories comprises at least five pre-defined material-type categories.

13. The method of controlling the travel of a vehicle (500) according to claim 7, wherein the plurality of pre-defined material-type categories comprises a plurality of material categories selected from a group consisting of: snow and ice, paint, wood and vegetation, asphalt, building materials and galvanized sheet metal.

14. The method of controlling the travel of a vehicle (500) according to claim 7, wherein the comparing reflectance values of the plurality of reflected signals (114) comprises comparing intensity values of the plurality of reflected signals (114).

15. A vehicle (500) comprising:
a chassis (502); and
a light detection and ranging system (100) coupled to the chassis (502), the light detection and ranging system (100) comprising:
a transmitter (102) configured to be coupled to the vehicle (500) and to emit light (110) at three transmission wavelengths nominally in a range from 800 nm to 1700 nm;
a receiver (104) configured to be coupled to the vehicle (500) and to receive three reflected signals (114), each of the reflected signals (114) being a portion of an associated one of the three transmission wavelengths reflected to the receiver (104) from a roadway object (112) external to the vehicle (500); and
a controller (106) configured to be coupled to the receiver (104), the controller (106) configured to provide a categorization output in response to comparing reflectance values of the three reflected signals (114), the categorization output being representative of the roadway object (112) being categorized into an associated one of a plurality of pre-defined material-type categories, each of the plurality of pre-defined material-type categories comprising an associated plurality of potential material types associated with a roadway environment.

16. The vehicle (500) according to claim 15, wherein the controller (106) is configured to control the travel of the vehicle (500) in response to the categorization output.

17. The vehicle (500) according to claim 15, wherein the controller (106) is configured to compare the reflectance values of the three reflected signals (114) by determining ratios of the reflectance values of the three reflected signals (114).

18. The vehicle (500) according to claim 15, wherein the plurality of pre-defined material-type categories comprises at least five pre-defined material-type categories.

19. The vehicle (500) according to claim 15, wherein the plurality of pre-defined material-type categories comprises material a plurality of material categories selected from a group consisting of: snow and ice, paint, wood and vegetation, asphalt, building materials and galvanized sheet metal.

20. The vehicle (500) according to claim 15, wherein the reflectance values are intensity values of the three reflected signals (114).
